(19) United States
(12) Patent Application Publication
(10) Pub. No.: US 2011/0236606 A1
(43) Pub. Date: Sep. 29, 2011

(54) ORNAMENT ASSEMBLY AND TRANSMISSION MECHANISM USED THEREIN

(75) Inventor: LING-YUNG LIN, TAIPEI CITY (TW)

(73) Assignee: STUDIO ELUCEO LTD., TAIPEI (TW)

(21) Appl. No.: 12/732,620

(22) Filed: Mar. 26, 2010

(51) Int. Cl. G09F 19/02; A47G 35/00; F16H 25/08

(52) U.S. Cl. 428/7; 74/54

(57) ABSTRACT

An ornament assembly and a transmission mechanism are provided. The transmission mechanism includes the ornament assembly disposed therein and decorative figurines. The transmission mechanism includes a base member, a motivating unit, a power module and tappet rods. The base member has a plurality of receiving housings formed thereon. The motivating unit has a rotatory shaft crossed through the receiving housings and a plurality of eccentric wheels formed on the rotatory shaft The eccentric wheels are received in the receiving housings respectively. The power module is connected to one end of the motivating unit. Each of the tappet rods has a follower member formed on a lower end thereof and movably contacted the eccentric wheels. The decorative figurines are disposed on a top end of the tappet rods respectively. The transmission mechanism provides well expandable characteristics. The decorative figurines of the ornament assembly express a more vivid flying appearance.

### BACKGROUND OF THE INVENTION

1. Field of the Invention

The present invention relates to an ornament assembly and a transmission mechanism used therein, in particular, to an ornament assembly having a plurality of movable decorative figurines, and further to a transmission mechanism used in the ornament assembly to drive the decorative figurines to convey a flying theme for and not limited to seasonal holidays.

2. Description of Related Art

It is known to provide an ornament assembly wherein several decorative figurines are respectively supported on rods from a base member, so that the decorative figures may be displayed and moved to provide an appearance that is associated with a particular season, or holiday.

The decorative figurines on the ornament assembly may be movable relative to another one. For example, various music box ornaments have been disclosed, and have appeared on the market. These ornamental display assemblies are rotated or reciprocated by the driving mechanism through a transmission mechanism. However, conventional transmission mechanisms for used with the music box ornaments are commonly complicated and occupied space. Besides, numbers of decorative figures are limited and hard to expand because of the structure of conventional transmission mechanisms. Furthermore, the conventional decorative figurines of the ornament assembly can not express a flying appearance, so that this type of ornament assembly gives little attraction to consumers.

### SUMMARY OF THE INVENTION

In view of the aforementioned issues, the present invention provides an ornament assembly and a transmission mechanism used therein for the simplification of the transmission mechanism used in the ornament assembly. In addition, the transmission mechanism is provided with well expandable characteristics, which allows expanding the quantity of decorative figurines, and for decorative figurines to move in an expanding manner. Furthermore, our use of motions on seasonal decorative figurines of the ornament assembly creates a more vivid flying appearance.

To achieve the above-mentioned objectives, the present invention provides an ornament assembly used in an ornament assembly, which includes a base member, a motivating unit, a power module and a plurality of tappet rods. The base member has a plurality of receiving housings formed thereon. The motivating unit has a rotatory shaft crossed through the receiving housings and a plurality of eccentric wheels formed on the rotatory shaft. The eccentric wheels are received in the receiving housings respectively. The power module is connected to one end of the motivating unit. Each of the tappet rods has a follower member formed on a lower end thereof and movably contacted the eccentric wheels.

To achieve the above-mentioned objectives, the present invention provides an ornament assembly, including a transmission mechanism and a plurality of decorative figurines. The transmission mechanism includes a base member, a motivating unit, a power module and a plurality of tappet rods. The base member has a plurality of receiving housings formed thereon. The motivating unit has a rotatory shaft crossed through the receiving housings and a plurality of eccentric wheels formed on the rotatory shaft. The eccentric wheels are received in the receiving housings respectively. The power module is connected to one end of the motivating unit. Each of the tappet rods has a follower member formed on a lower end thereof and movably contacted the eccentric wheels. The decorative figurines are disposed on a top end of the tappet rods respectively.

The following beneficial effects according to the ornament assembly and transmission mechanism used therein of the present invention are described as follows. The transmission mechanism used in the ornament assembly is simplified. Furthermore, the present invention can easily expand the quantity of the movable decorative figurines, and the present invention can express a flying appearance with ascending/descending actions more vivid.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

FIG. 1 is a perspective exploded view of a transmission mechanism according to the present invention;

FIG. 2 is a perspective assembled view of the transmission mechanism according to the present invention;

FIG. 3 is a perspective exploded view of another embodiment of the transmission mechanism according to the present invention;

FIG. 4 is another exploded view of another embodiment of the transmission mechanism according to the present invention;

FIG. 5 is a perspective view of an ornament assembly according to the present invention;

FIG. 6 is a perspective view of second embodiment of the ornament assembly according to the present invention;

FIG. 7 is a perspective view of third embodiment of the ornament assembly according to the present invention; and

FIG. 8 is a perspective view of fourth embodiment of the ornament assembly according to the present invention is illustrated.

### DETAILED DESCRIPTION OF THE PREFERRED EMBODIMENTS

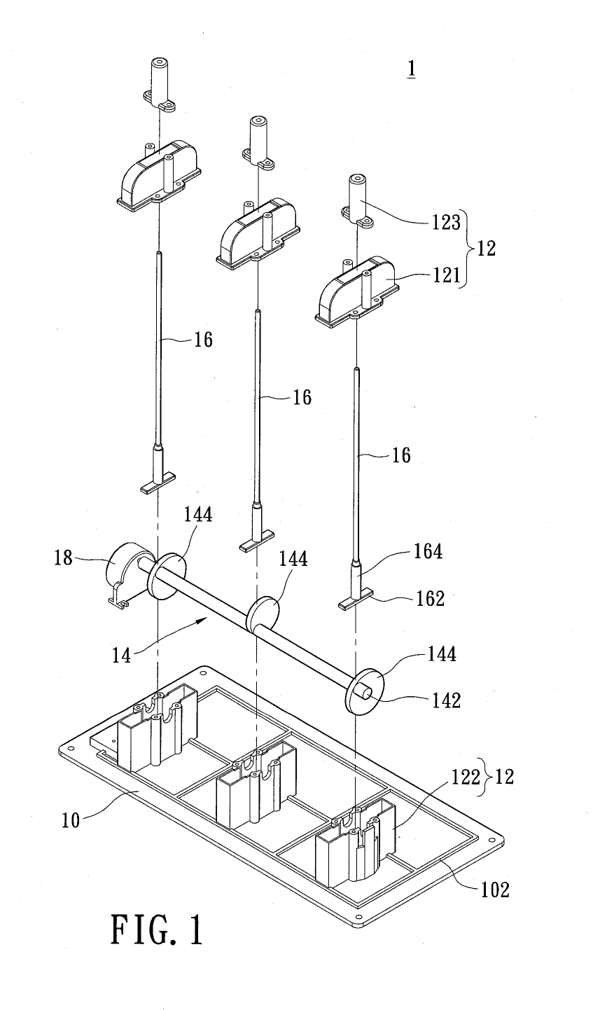

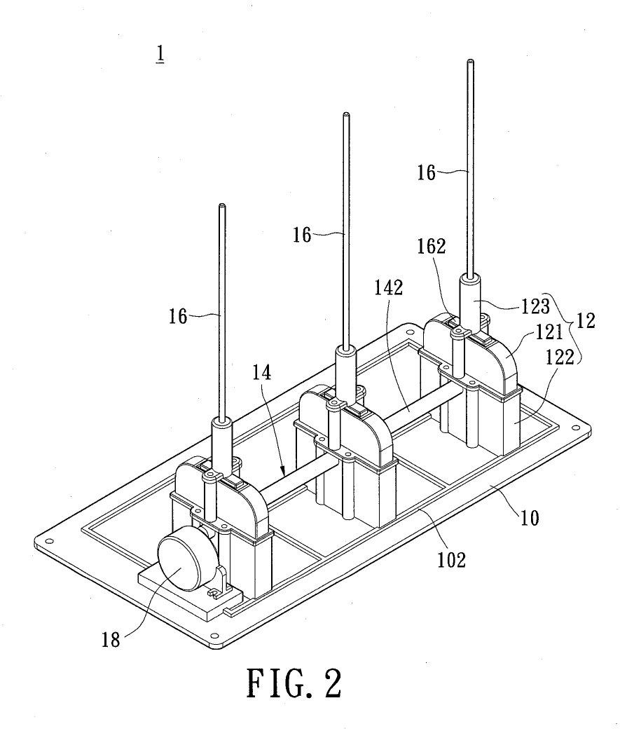

Referring now to FIGS. 1 to 2, in which a perspective exploded and assembled views of a transmission mechanism according to the present invention are disclosed. The present invention provides a transmission mechanism 1, which could be used in an ornament assembly, includes a base member 10, a motivating unit 14, a plurality of tappet rods 16 and a power module 18.

The base member 10 in this embodiment is a plate-shaped board, and has a plurality of receiving housings 12 which are formed on a top surface of the base member 10. To strength its structure, the base member 10 could be upwardly protruded a plurality of ribs 102 on a top side thereof.

In this embodiment, each of the receiving housings 12 further includes a lower housing 122 and an upper housing 121. The upper housing 121 could be mounted on the lower housing 122 by screws (not shown). The lower housing 122 could be integrally formed on the base member 10, and the material can be plastic, so that the base member 10 and the receiving housings 12 can be produced on a mass scale. The tappet rods 16 transversely pass through the upper housings 121.

The motivating unit 14 has a rotatory shaft 142 and a plurality of eccentric wheels 144 formed on the rotatory shaft 142 with intervals. The rotatory shaft 142 crosses through the receiving housings 12. The eccentric wheels 144 are received in the receiving housings 142 respectively. The eccentric wheels 144 could be integrally formed on the rotatory shaft 142.

The tappet rods 16 are used to support decorative figurines on the top ends respectively. Each of the tappet rods 16 has a follower member 162 which is formed on a lower end thereof and movably contacts the eccentric wheels 144. In this embodiment, the follower member 162 is plate shaped. The bottom surface of the follower member 162 contacts with the eccentric wheel 144. When the eccentric wheel 144 is driven and rotated, the follower member 162 follows a periphery of the eccentric wheel 144 to ascend and descend. Thereby, the tappet rods 16 can be moved upwardly/downwardly with the decorative figurines.

To limit the tappet rods 16 to move along the erect direction, each of the receiving housings 12 further includes a sleeve member 123. The sleeve member 123 is mounted on the upper housing 121 by screws (not shown). Each of the tapper rods 16 is slidably passed through the rod sleeves 123 respectively. Besides, in this embodiment, the tappet rods 16 includes a stroke portion 164 which is formed at a lower portion thereof and above the follower portion 162. The stroke portion 164 is slidably received in the sleeve member 123. The length of the stroke portion 164 is substantially equal to a depth of an inner space formed in the sleeve member 123, and the length of the stroke portion 164 is substantially longer or equal to a radial of the eccentric wheel 144. Therefore, the stoke portion 164 can reciprocate in the sleeve member 123.

The power module 18 is used to rotate the rotatory shaft 142 and is connected to one end of the motivating unit 14. In this embodiment, the power module 18 is mounted on the base member 10 and is adjacent to one of the outmost receiving housings 12. The power module 18 could be composed of a motor and several gears. The rotatory shaft 142 could be provided with a gear at one end thereof to engage with one gear of the power module 18, so that a power can be transmitted from the power module 18 to the motivating unit 14. Alternatively, the power module 18 could be a driving mechanism (clock-work) of a wind-up music box mechanism.

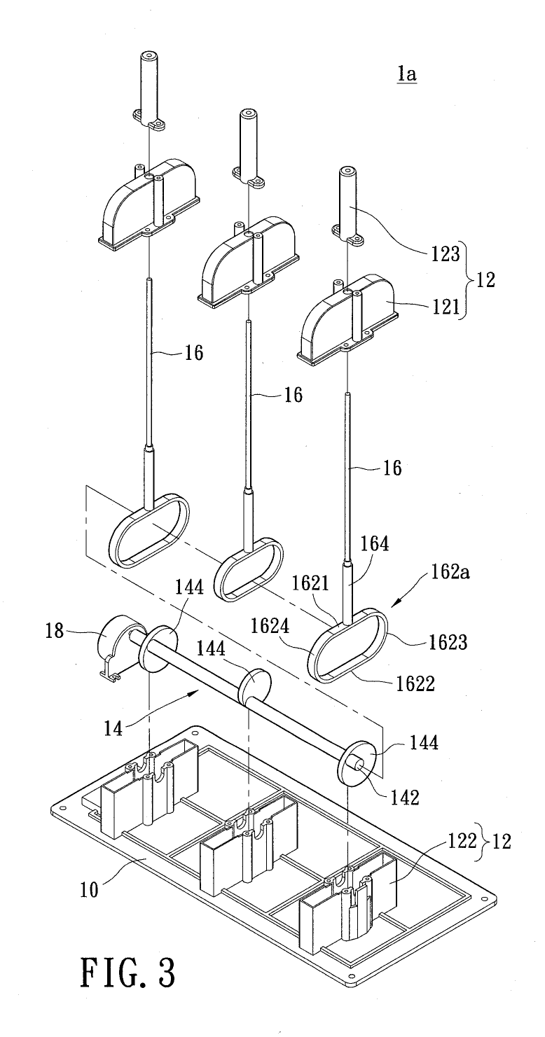

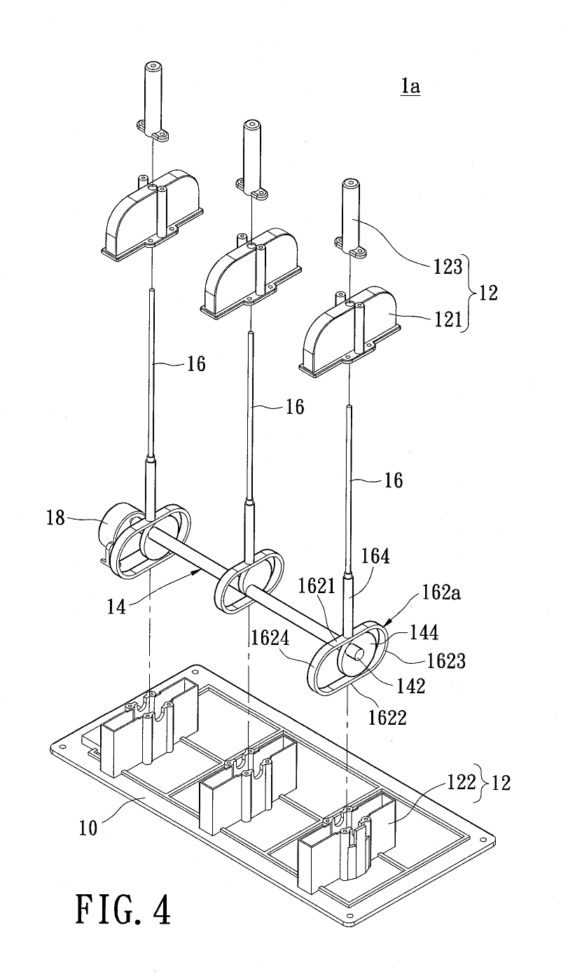

Referring now to FIGS. 3 to 4, in which perspective exploded views of another embodiment of the transmission mechanism according to the present invention are disclosed. In this present embodiment, different tappet rods 16a are illustrated, in which the follower member 162a is substantially oval-shaped. The follower member 162a has a pair of plate portions 1621, 1622 and a pair of arc portions 16213, 1624 respectively connected two ends of the plate portions 1621, 1622. The eccentric wheel 144 is disposed and limited in the follower member 162a. In this embodiment, the advantage is that the tappet rods 16 will always follow the eccentric wheel 144. When a top periphery of the eccentric wheel 144 is ascending, the upper plate portions 1621 is propped up by the eccentric wheel 144. When a top periphery of the eccentric wheel 144 is descending, the lower plate portions 1622 is pressed down by the eccentric wheel 144. Comparing with the first embodiment, it can avoid the tappet rod 16 is not fallen down by gravity, when the top periphery of the eccentric wheel 144 is descending. Consequently, the move of the tappet rods 16 will be smoothly.

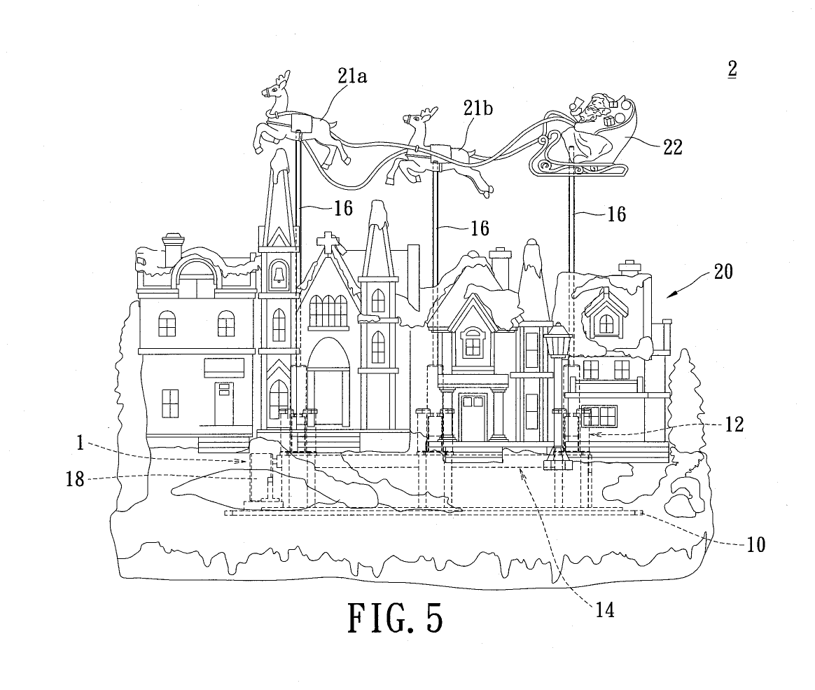

Referring now to FIG. 5, in which a perspective view of an ornament assembly according to the present invention is illustrated. An ornament assembly 2 is illustrated, which has a scenery member 20 almost covered the transmission mechanism 1, and the tappet rods 16 are extended outside the scenery member 2. The ornament assembly 2 further includes a plurality of decorative figurines, for example, two reindeer figurines 21a, 21b with reins and a Santa Claus figurine 22, are respectively supported on the top of the tappet rods 16. The scenery member 20 could be different for being associated with the season or holiday, such as a church building, Christmas trees, a snowman, or a horse-drawn carriage (not labeled). In this present invention, the decorative figurines can express a flying appearance in a row.

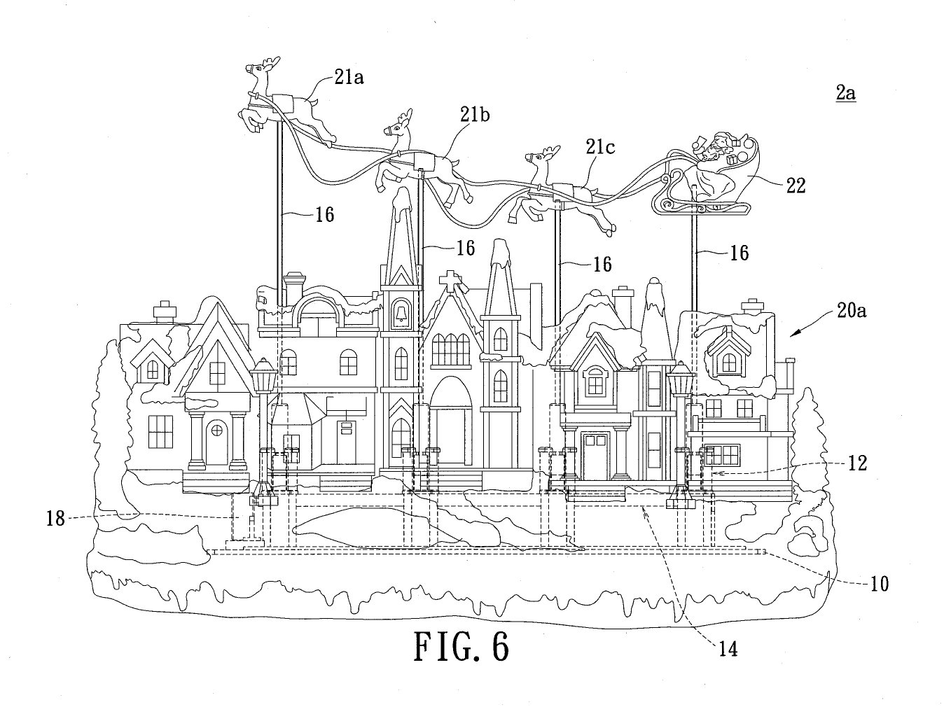

Referring now to FIG. 6, in which a perspective view of second embodiment of the ornament assembly with four decorative figurines according to the present invention is illustrated. Moreover, the present invention can easily expand the quantity of the movable decorative figurines, because the motivating unit 14 can be provided with one more eccentric wheel 144 with a longer extended rotatory shaft 142. In this embodiment, an ornament assembly 2a has four decorative figurines, including three reindeer figurines 21a, 21b, 21c, and the Santa Claus figurine 22.

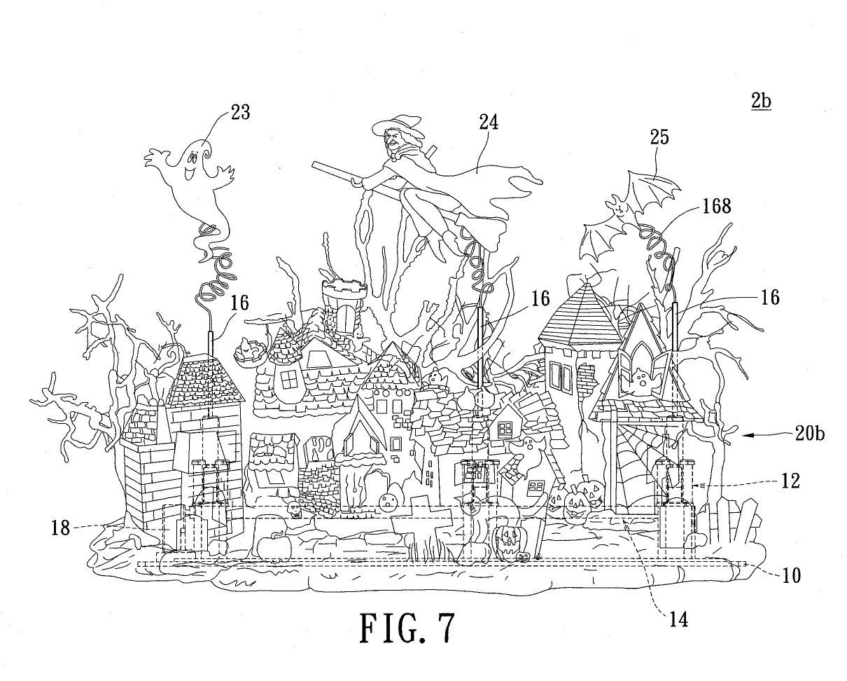

Referring now to FIG. 7, in which a perspective view of third embodiment of the ornament assembly according to the present invention is illustrated. In this embodiment, an ornament assembly 2b is provided and includes a scenery member 20b of broken houses, a ghost figurine 23, a witch figurine 24 and a bat figurine 25. Besides, the tappet rod 16 further includes a flexible portion 168 connected between the decorative figurines 23, 24, 25 and the tappet rod 16. The flexible portion 168 could provide a waving and tremble appearance for these decorative figurines 23, 24, 25, so that a flying appearance with ascending/descending actions is more vivid. In this embodiment, the flexible portion 168 is spring shaped.

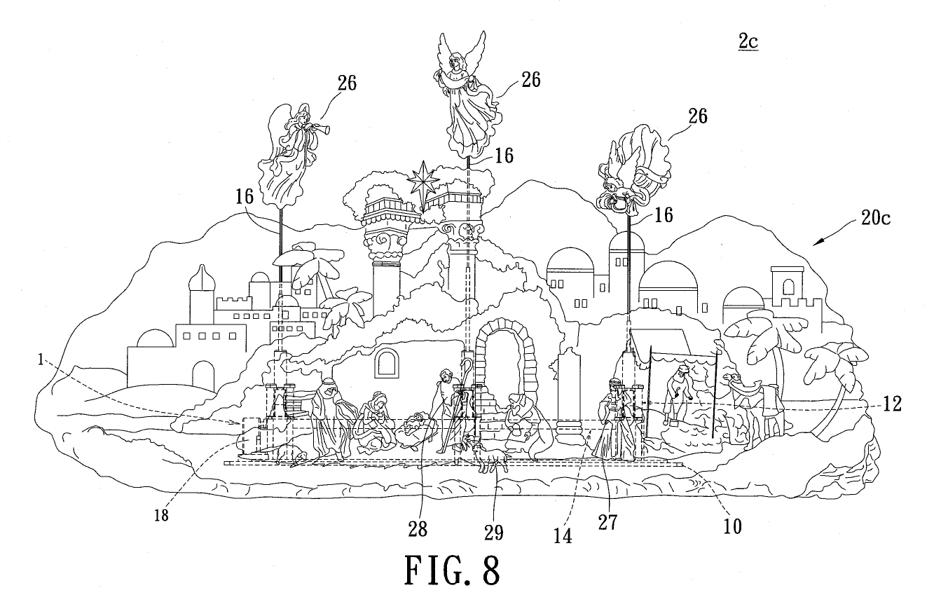

Referring now to FIG. 8, in which a perspective view of fourth embodiment of the ornament assembly according to the present invention is illustrated. In this embodiment, an ornament assembly 2c is provided and includes a scenery member 20c of Jesus born in a manger, and three angel figurines 26 flying above to praise God. There are also some doll figurines which are decorated in front of the scenery member 20c, such as magi 27, shepherd 28 and lamps 29.

The scenery member 20, 20a, 20b, and 20c could be made of paper, so that it is easily to be changed by consumers themselves. Furthermore, those doll figurines could be movable, so that the consumers can move them. Therefore, the ornament assembly according to the present invention can provide more amusement for consumers.

The present invention has the advantages as follows.

1. The transmission mechanism used in the ornament assembly is simplified. The motivating unit 14 is simplified and formed integrally. The power module 18 is smaller than the conventional one and occupied a less space.

2. The present invention can easily expand the quantity of the movable decorative figurines, because the transmission mechanism provided can extend the rotatory shaft 142 easily with more eccentric wheels 144.

3. The present invention can express a flying appearance with ascending/descending actions more vivid. Through the flexible portion 168, it could provide a waving and tremble appearance for these decorative figurines 23, 24, 25. Therefore, the ornament assembly of the present invention can give more attraction to consumers.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A transmission mechanism, used in an ornament assembly, comprising:
a base member having a plurality of receiving housings formed thereon;
a motivating unit having a rotatory shaft crossed through the receiving housings and a plurality of eccentric wheels formed on the rotatory shaft, the eccentric wheels received in the receiving housings respectively;
a power module connected to one end of the motivating unit; and
a plurality of tappet rods, each of the tappet rods having a follower member formed on a lower end thereof and movably contacted the eccentric wheels.

2. The transmission mechanism according to claim 1, wherein each of the receiving housings further comprises a lower housing and an upper housing mounted on the lower housing, the lower housing is integrally formed on the base member.

3. The transmission mechanism according to claim 2, wherein each of the receiving housings further comprises a sleeve member mounted on the upper housing, and each of the tapper rods is slidably passed through the rod sleeves respectively.

4. The transmission mechanism according to claim 3, wherein the tappet rod further comprises a stroke portion formed at a lower portion thereof and above the follower portion, the stroke portion is slidably received in the sleeve member.

5. The transmission mechanism according to claim 4, wherein the stroke portion has a length substantially equal to a radial of the eccentric wheel.

6. The transmission mechanism according to claim 1, wherein the eccentric wheels are integrally formed on the rotatory shaft.

7. The transmission mechanism according to claim 1, wherein the follower member of the tappet rod is plate shaped and is slidably contacted the eccentric wheel.

8. The transmission mechanism according to claim 1, wherein the follower member of the tappet rod is substantially oval-shaped, and has a pair of plate portions and a pair of arc portions respectively connected two ends of the plate portions, and the eccentric wheel is disposed in the follower member.

9. The transmission mechanism according to claim 1, wherein the power module is mounted on the base member and is adjacent to one of the outmost receiving housings.

10. The transmission mechanism according to claim 1, wherein the base member is protruded upwardly a plurality of ribs.

11. An ornament assembly, comprising:
a transmission mechanism, including
a base member having a plurality of receiving housings formed thereon;
a motivating unit having a rotatory shaft crossed through the receiving housings and a plurality of eccentric wheels formed on the rotatory shaft, the eccentric wheels received in the receiving housings respectively;
a power module connected to one end of the motivating unit; and
a plurality of tappet rods, each of the tappet rods having a follower member formed on a lower end thereof and movably contacted the eccentric wheels; and
a plurality of decorative figurines disposed on a top end of the tappet rods respectively.

12. The ornament assembly according to claim 11, further comprising a flexible portion connected between the decorative figurine and the tappet rod.

13. The ornament assembly according to claim 12, wherein the flexible portion is spring shaped.

14. The ornament assembly according to claim 11, further comprising a scenery member covered the transmission mechanism, wherein the tappet rods are extended outside the scenery member.

15. The ornament assembly according to claim 14, wherein the scenery member is made of paper.

16. The ornament assembly according to claim 11, wherein the decorative figurines are composed of at least two reindeer figurines and a Santa Claus figurine.

17. The ornament assembly according to claim 11, wherein the decorative figurines are composed of a ghost figurine, a witch figurine and a bat figurine.

18. The ornament assembly according to claim 11, wherein the decorative figurines are composed of a plurality of angel figurines.
